(19) United States
(12) Patent Application Publication
(10) Pub. No.: US 2011/0185369 A1
(43) Pub. Date: Jul. 28, 2011

(54) REFRESH OF AUXILIARY DISPLAY

(75) Inventor: Hung Khei Huang, Irvine, CA (US)

(73) Assignee: CANON KABUSHIKI KAISHA, Tokyo (JP)

(21) Appl. No.: 12/693,264

(22) Filed: Jan. 25, 2010

(51) Int. Cl. G06F 3/00; G06F 17/00

(52) U.S. Cl. 719/321; 715/234

(57) ABSTRACT

A system includes an information processing apparatus and a display. The apparatus has at least one processor coupled via a bus to a memory, the processor being programmed to control one or more of a content generation unit to generate content for display, wherein the content includes a page having a plurality of content elements, an ID generating unit to generate content IDs corresponding to each of the content elements in the generated page, a content refresh determination unit to determine a content ID of at least one content element to be refreshed on the display, and a device driver to receive the generated content and transmit instructions to the display to cause display of the content. The device driver receives the content ID for the at least one content element to be refreshed, and transmits instructions to cause refresh of the at least one content element corresponding to the content ID at the identified page location.

### BACKGROUND OF THE INVENTION

1. Field of the Invention

Aspects of the present invention relate to refreshing an auxiliary display that is a part of a system including an information processing apparatus.

2. Description of the Related Art

Users of computers and other information processing apparatuses increasingly demand improved convenience and performance in accessing information and tools on these devices. One example of a recent technology that improves such user access is the Windows® Sidebar infrastructure, included in the Windows® Vista desktop, which provides mini-applications referred to as “gadgets” that are grouped together in a panel on the side of the desktop display. The gadgets can provide quick access to content such as weather information, traffic maps, and business data, for example by connecting to the internet, and may also be capable of accessing programs running on the device to give a quick view of scheduling information, calendars, contacts, e-mail messages, etc. Other examples of gadget functionalities can include, for example, calculators, media players and slideshow viewers. The gadget mini-applications provide advantages in that they can allow a user to quickly and conveniently view information and/or use tools therewith, without requiring start-up and operation of an entire software application. For example, to obtain weather information, a user may simply view a weather gadget in the Windows® Sidebar panel, rather than starting-up an internet browser application and navigating to a weather information page.

The drive towards improved user access has also resulted in the development of technology that allows for the display of such gadgets or other mini-applications on auxiliary displays and devices, such as for example integrated displays embedded on the external panels of laptop lids, as well displays on external devices such as mobile phones and remote controls. An example of such technology is the Microsoft® Sideshow infrastructure, which allows certain applications and/or programs, such as for example gadgets, that are running on a primary device (e.g., laptop, desktop P.C., etc) to be displayed on and accessed via an auxiliary display. In some cases, the applications and/or programs displayed on the auxiliary display using the Windows® Sideshow infrastructure may correspond to the Windows® Sidebar gadgets. However, the Windows® Sideshow infrastructure is not limited to the display of only Windows® Sidebar gadgets, and other programs, gadgets and/or mini-applications other that those corresponding to the Windows® Sidebar infrastructure may also be displayed. Furthermore, it may be possible for a user to selectively choose the programs and/or gadgets for display on the auxiliary device via the Windows® Sideshow infrastructure, for example such that the auxiliary device may display only a portion of the full complement of gadgets and/or programs that may be otherwise available on the primary device. The Windows® Sideshow infrastructure provides advantages in that the mini-applications or gadgets can be run on the auxiliary display in a relatively efficient manner, allowing them to be accessed even when the primary device (e.g., laptop, desktop PC, etc.), is in sleep mode or is powered off. Thus, a user seeking to access a gadget or other mini-application, such as to get a quick-view of a schedule, or to review an e-mail message, may be able to do so without having to power-up the primary device. For a laptop having an integrated auxiliary display screen on an outer panel of the laptop lid, the user may even be able to access the gadgets via the outer panel screen without having to open the laptop lid.

In the operation of the Microsoft® Sideshow infrastructure, the auxiliary display on which content is to be provided interacts with a device driver of the primary device (e.g., laptop, desktop P.C., etc.), which in turn interacts with a Microsoft® Sideshow Manager to obtain the display contents from the gadgets. The contents are tagged with IDs that correspond to each page to be displayed. Thus, when a device driver prepares to send a page of display content to the auxiliary display, it first requests the updated page, using the page ID, from the relevant gadget via the Sideshow Manager, and then sends the received content of the page to the auxiliary display. The data sent to the auxiliary device is typically in the form of bitmap or xml data, although other data forms agreed upon between the device driver and auxiliary display can also be used.

Accordingly, in the operation flow described above, whenever information is to be refreshed and/or updated on the auxiliary display, the full contents of the page to be refreshed are sent from the gadget to the Sideshow Manager, from the Sideshow Manager to the device driver, and finally to the auxiliary display. However, the amount of data sent for the refreshing operation can be quite substantial, as in the case of an auxiliary device that receives a bitmap image from the device driver. Thus, for gadget functionalities that involve frequent refresh of the contents, this operation flow can result in a poor performance and a reduction in the quality of the overall user experience due to the relatively slow screen update. The content displayed on the auxiliary display may be refreshed, for example, when a user has indicated a request for a particular display of information from the gadget, or when the content to be displayed has otherwise been changed (e.g., an automatic update of time or weather information).

Accordingly, there remains a need for a method and system for the refreshing of content displayed on an auxiliary display, such as display content provided by gadgets and other mini-applications, that provides for an increase in the rate of refreshing and/or updating of the display content, and thus improves user access to the content viewed on the auxiliary display.

### SUMMARY OF THE INVENTION

According to one aspect of the invention, a system includes an information processing apparatus and a display configured to display content from the information processing apparatus. The information processing apparatus has at least one processor coupled via a bus to a memory, the processor being programmed to control one or more of a content generation unit configured to generate content for display, wherein the content includes a page having a plurality of content elements, an ID generating unit configured to generate content IDs corresponding to each of the content elements in the page of the content generated by the content generation unit, a content refresh determination unit configured to determine a content ID of at least one content element to be refreshed on the display, and a device driver configured to receive the content generated by the content generation unit and transmit instructions to the display to cause display of the content thereon. The device driver is configured to receive the content ID for the at least one content element to be refreshed on the display, as determined by the content refresh determination unit, identify a location of the at least one content element on the displayed page based on the content ID, and transmit instructions to cause the display to refresh the at least one content element corresponding to the content ID at the identified page location.

According to another aspect of the invention, an information processing apparatus is configured to provide content for a display. The information processing apparatus has at least one processor coupled via a bus to a memory, the processor being programmed to control one or more of a content generation unit configured to generate the content for the display, wherein the content includes a page having a plurality of content elements, an ID generating unit configured to generate content IDs corresponding to each of the content elements in the page of the content generated by the content generation unit, a content refresh determination unit configured to determine a content ID of at least one content element to be refreshed on the display, and a device driver configured to receive the content generated by the content generation unit and transmit instructions to the display to cause display of the content thereon. The device driver is configured to receive the content ID for the at least one content element to be refreshed on the display, as determined by the content refresh determination unit, identify a location of the at least one content element on the displayed page based on the content ID, and transmit instructions to cause the display to refresh the at least one content element corresponding to the content ID at the identified page location.

### BRIEF DESCRIPTION OF THE DRAWINGS

FIG. 1 is a block diagram illustrating a system having an information processing apparatus and a display that is configured to display content from the information processing apparatus according to an exemplary embodiment of the invention.

FIG. 2 is a block diagram illustrating a system having an information processing apparatus comprising one or more gadgets to generate display content, a communication management unit to manage communication between the gadgets and a driver, and a display configured to display content received from the information processing apparatus, according to an exemplary embodiment of the invention.

FIG. 3A is a block diagram illustrating an information processing apparatus for the refreshing and/or updating of at least one content element on a display, according to an exemplary embodiment of the invention.

FIG. 3B is a block diagram illustrating a display configured to display information from an information processing apparatus, and configured to receive refresh instructions for refreshing at least one content element on a displayed page, according to an exemplary embodiment of the invention.

FIG. 4 is a block diagram illustrating an example of the internal architecture of an information processing apparatus configured to transmit instructions to a display to update and/or refresh the content displayed thereon, according to an exemplary embodiment of the present invention.

FIG. 5 is a flow diagram illustrating a user initiated and/or gadget initiated updating of content on a display, according to an exemplary embodiment of the present invention.

FIG. 6A illustrates a flow diagram for updating contents of a display as initiated by an event from an information processing apparatus, according to an exemplary embodiment of the invention.

FIG. 6B illustrates a flow diagram for requesting updated display content as initiated by an event from a display, according to an exemplary embodiment of the invention.

FIG. 6C illustrates a flow diagram for updating contents of a display as initiated either by a user of the display or a gadget of an information processing apparatus, according to an exemplary embodiment of the invention.

FIGS. 7A-7C illustrate diagrams showing schemes for the display of content elements on a display page, according to exemplary embodiments of the invention.

FIG. 8A illustrates examples of SCF elements used for display of a page, according to an exemplary embodiment of the invention.

FIG. 8B illustrates examples of additional SCF elements provided as a part of an SCF extension for updating content elements of a displayed page, according to an exemplary embodiment of the invention.

FIGS. 9A-9B are diagrams illustrating the relationship between SCF elements and/or attributes and the refreshing of contents on a displayed page, according to exemplary embodiments of the invention.

### DESCRIPTION OF THE EMBODIMENTS

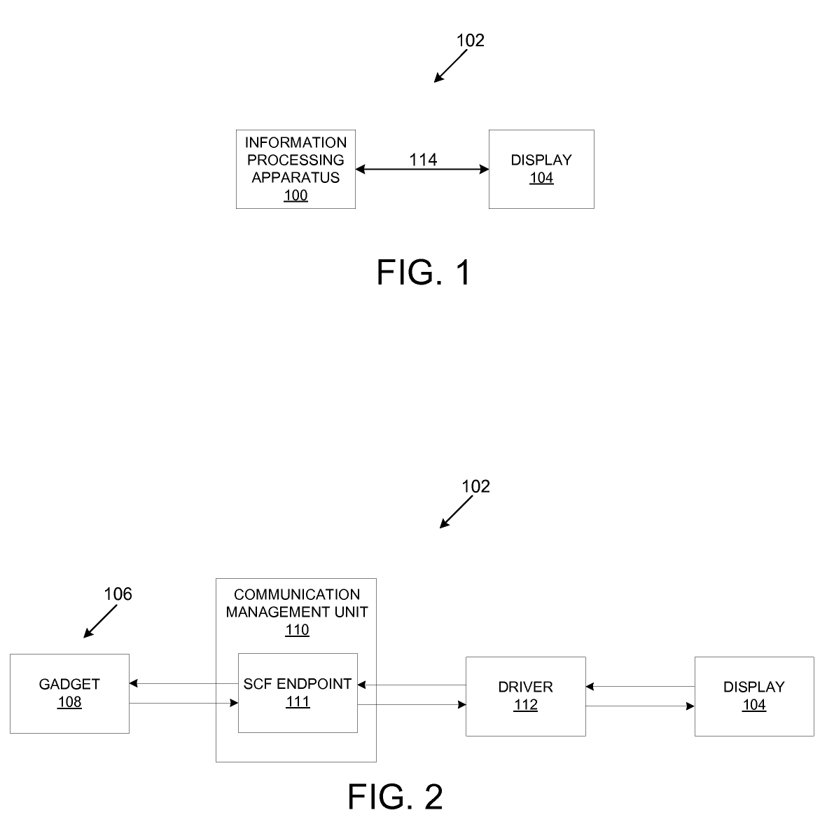

Exemplary embodiments of the present invention provide for the refreshing and/or updating of the contents of a display 104, such as a display 104 that is auxiliary to a main display of an information processing apparatus 100. Pursuant to these exemplary embodiments, a system 100 may be provided that comprises an information processing apparatus 100 and a display 104 that is configured to display content from the information processing apparatus 100, as shown in FIG. 1. The display 104 is communicatively coupled to the information processing apparatus 100 so as to receive content generated by the information processing apparatus 100 and display the content thereon. For example, the display 104 may be a part of a separate remote device that is connected to the information processing apparatus 100 via either a wireless (not shown) or wired network connection 114. As another example, the display 104 may be integrated into the structure of the information processing apparatus 100 itself to form a part of the apparatus.

According to aspects of the invention, suitable information processing apparatuses 100 may include, for example, desktop PCs, laptops, and other devices that are capable of generating content for display. The displays 104 that are updated and/or refreshed according to the aspects of the invention can include auxiliary displays such as displays on remote devices, as well as displays that are integrated into the information processing apparatus 100, such as built-in screens, and other display monitors. For example, the display 104 may be an auxiliary display that is integrated into the outside panel of a laptop, to allow for the viewing of content without opening the lid of the laptop. The display 104 may also be provided on mobile devices such as for example PDA devices, remote controls, cellular phones, and the like, as well as on devices such as keyboards, computer mice and other computer controllers, TVs, stereos, GPS devices, watches, and the like. Additionally, embodiments of the invention may provide for the updating and/or refreshing of the contents displayed on a single display 104, or may even allow for the refreshing of contents displayed on multiple displays 104, each of which are communicatively coupled to the information processing apparatus 100.

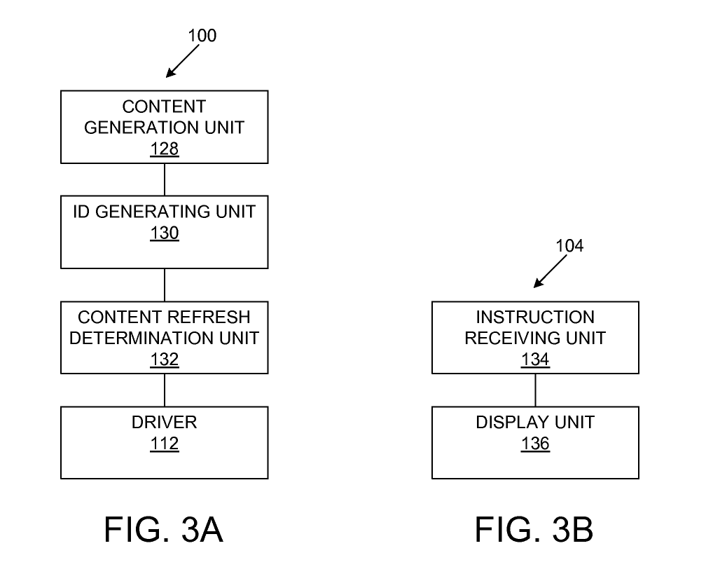

Referring to FIG. 2, an exemplary embodiment of a system 102 having the information processing apparatus 100, and the display 104 configured to display content from the information processing apparatus 100, is shown. According to this embodiment, the information processing apparatus 100 comprises one or more gadgets 108 and/or mini-applications that may be managed by a gadget management unit 106. An example of a gadget management unit 106 may be a unit operating in accordance with the Windows® Sideshow infrastructure, although aspects of the invention are not limited thereto, and other gadget management units 106 corresponding to other infrastructures may also be used. The information processing apparatus 100 further comprises a communication management unit 110 that is capable of managing communicating between the gadgets 108 and a driver 112 of the information processing apparatus 100, which unit may operate in accordance with, for example, the Microsoft® Sideshow infrastructure. The driver 112 is configured to communicate content and/or instructions to and from the display 104, and may comprise, for example, a Microsoft® Sideshow device driver. In the embodiment as shown in FIG. 2, the driver 112 of the information processing apparatus 100 communicates with a device having the display 104 via a wireless or wired network 114, although the invention is not limited to this embodiment. While Windows® Sideshow is referred to herein for purposes of illustrating aspects of the invention, it should be understood that any other infrastructure, applications, programs and/or devices that may be suitable for the practice of aspects according to the present invention may also be applicable.

The gadget management unit 106 may be configured to provide for the management and viewing of information and/or data provided by one or more mini-programs, hereinafter referred to as the “gadgets” 108, which are provided on the information processing apparatus 100. In one embodiment, the program management unit 106 may be one that operates in accordance with the Windows® Sideshow infrastructure. The program management unit 106 may thus provide an interface by which a user can view the gadget information and can select, or alternatively remove, gadgets 108 for display. However, while the Windows® Sideshow infrastructure is referred to herein as being suitable for a program management unit, a unit that operates according to an infrastructure that is other than the Windows® Sideshow infrastructure and that would provide for practice of aspects according to the present invention may also be applicable. Alternatively, according to aspects of the invention, one or more of the gadgets 108 and/or mini-applications may be provided as stand-alone programs, which may be capable of operating and interfacing with the communication management unit 110 without the aid of a gadget management unit 106.

The gadgets 108 are mini-programs and/or mini-applications that are capable of generating content for display on a display 104 of the system 100. The content generated by the gadgets 108 may provide a user with access to various information, data and/or tools. According to one aspect of the invention, the content generated by the gadgets 108 can comprise one or more pages of content, each page having a plurality of content elements. The content generated by the gadgets 108 may be displayed on, for example, a main display of the information processing apparatus 100, as well as on another display 104, such as for example an auxiliary display that is integrated with the information processing apparatus 100 or that is provided on a remote device.

Examples of gadgets 108 that may be suitable for use with embodiments of the invention can include mini-programs that are capable of accessing web services to provide at-a-glance access to information such as weather information, traffic maps, new updates, internet radio streams, slide shows of online photo albums and business data. The gadgets 108 may also comprise mini-programs capable of locally accessing and integrating with programs running on the information processing apparatus, to give a quick view of information such as scheduling information, calendars, contacts and e-mail messages. Other examples of gadget functionalities can include, for example, calculators and media players. In one embodiment, the gadgets 108 correspond to gadgets that operate as a part of the Microsoft Windows® Sideshow infrastructure, although embodiments of the invention are not limited thereto.

The communication management unit 110 can be configured to provide for the communication of information between the gadgets 108 and the driver 112. In one embodiment, the communication management unit 110 corresponds to the Microsoft® Sideshow infrastructure, which is capable of managing communication between one or more gadgets 108 and/or mini-applications and the driver 112, to provide content to an auxiliary display. The Microsoft® Sideshow infrastructure may use a SCF endpoint (single content format endpoint) schema 111 to communicate content between the gadgets 108 and a driver 112. While the Windows® Sideshow infrastructure is referred to herein as a suitable communication management unit 110, a unit that operates according to an infrastructure that is other than the Windows® Sideshow infrastructure and that would provide for practice of aspects according to the present invention may also be applicable.

The driver 112 can be configured to implement an interface between the communication management unit 110 and the display 104 that displays content generated by the gadget 108. Generally, the driver 112 allows the information processing apparatus 100 to receive information and/or data from the display 104, and to transmit instructions to the display 104 to provide control thereof, such as for example to control the content shown on the display, as well as to refresh and/or update the content on the display 104. For example, the driver 112 may be capable of receiving content generated by the one or more gadgets 108, via the communication management unit 110, and transmitting instructions to the display 104 to cause display of the generated content thereon. The driver 112 may also be capable of receiving instructions originating from a user viewing the display 104 and/or a device on which the display 104 is provided, such as for example instructions from a user operating the display 104 requesting additional content from one or more of the gadgets 108.

According to one aspect, the display 104 may be a part of a device (not shown) that is capable of functioning as a bitmap device simulator. The display 104 may thus be capable of displaying a bitmap provided by the driver 112, and sending information and/or instructions back to the driver 112 whenever a user selects an option and/or requests information on the device having the display 104 via a user interface.

An improvement in the refresh and/or update rate of the display 104 may be provided by refreshing and/or updating the display 104 in accordance with a content ID that corresponds to an element of the content being displayed. Thus, when the content of a displayed page is to be refreshed and/or updated, such as for example when a user has requested specific content from a gadget 108, or when the information provided by the gadget 108 has been updated by an external source, the content on the displayed page may be refreshed by updating only the particular element or elements corresponding to the new content, without refreshing the remainder of the page. Accordingly, in one embodiment, each page generated by the gadget 108 for display is tagged with a plurality of content IDs, with each content ID corresponding to one of a plurality of different elements displayed on the page, such that the particular elements to be updated can be uniquely identified.

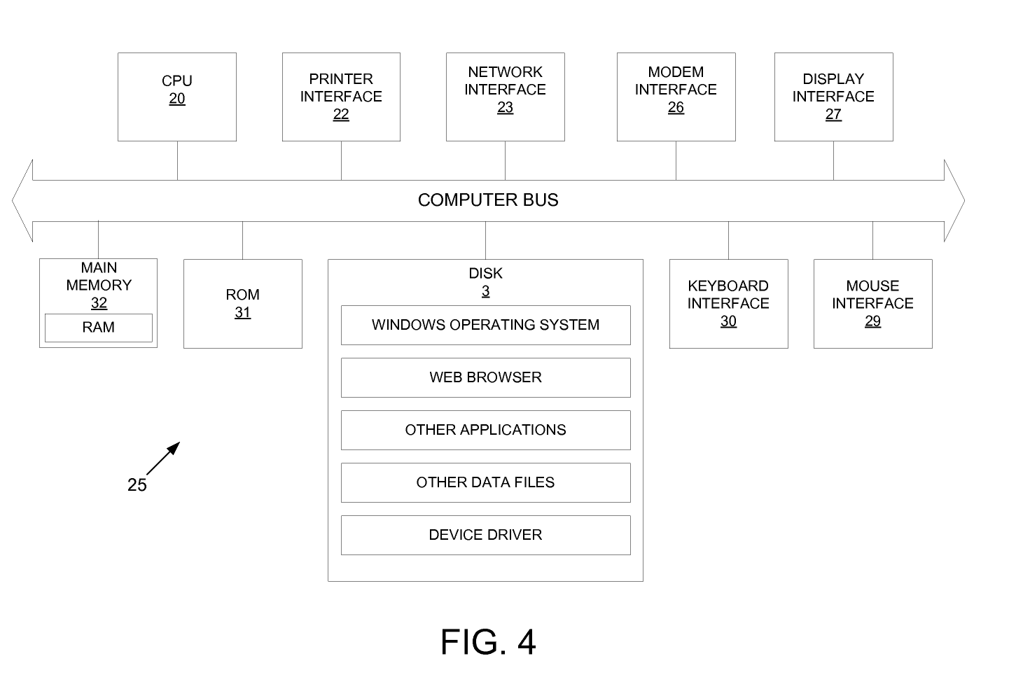

Referring to FIG. 3A, an embodiment of a system 100 according to aspects of the invention thus comprises an ID generating unit 130 configured to generate content IDs corresponding to each of the content elements in a page of content. Accordingly, in this embodiment, one or more pages of content is generated by a content generation unit 128 that is capable of generating such content, such as for example one or more of the gadgets 108. The content IDs for each element in each page of the content is generated by the ID generating unit 130, which may be included in one or more of the gadgets 108 and/or the gadget management unit 106. Alternatively, the content IDs may be generated and assigned to the content elements by other components of the information processing apparatus 100, such as for example the communication management unit 110 or the driver 112. The element types having their own content IDs may correspond to, for example, at least one of an image element, button element, content element, text element, dialog element, menu element and item element, among others, which elements may each be displayed as a part of a page that is sent to the display 104. The ID generating unit 130 may be capable of generating a content ID that is associated with information identifying a type of the content element.

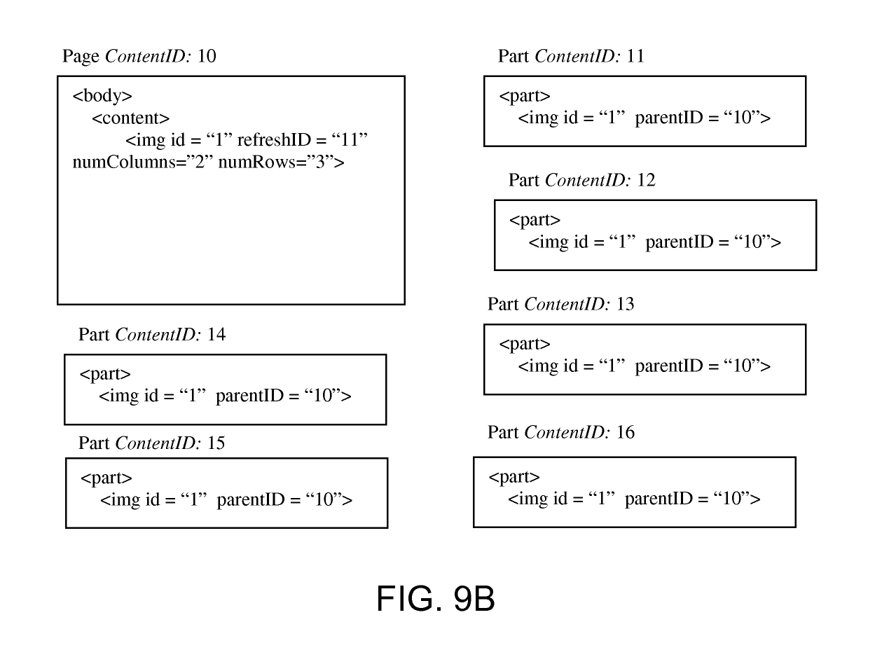

According to one aspect of the invention, the ID generating unit 130 may be capable of generating a content ID that is associated with information identifying the page to which the content element belongs, as shown for example in FIGS. 9A-9B, which are described below. According to another aspect, the ID generating unit 130 may be capable of generating a page ID for each page of content generated by the content generation unit 128, with the page ID being associated with information identifying each content element (e.g., part) in the page, as shown for example in FIG. 9A. For example, the page ID may be associated with information identifying a row and a column where a content element is located in an image included in the page, as shown for example in FIG. 9B.

The system 100 further comprises a content refresh determination unit 132 that is configured to determine the content ID of at least one content element that is to be refreshed on the display 104. Accordingly, when a portion of a page shown on the display 104 is to be refreshed and/or updated, the content ID of at least one content element corresponding to that portion can be determined. The content refresh determination unit 132 may, for example, be included in the driver 112 to identify the content ID of an element to be refreshed and/or updated according to instructions originating from the display 104. The one or more gadgets 108 may also be capable of functioning as a content refresh determination unit 132, for example by identifying the content ID of an element that is independently updated, such as via automatic update from an internet connection, and transmitting the updated element and corresponding content ID number to the driver 112 via the communication management unit 110.

The driver 112 is further configured to receive the content ID for at least one content element to be updated and/or refreshed on the display, as determined by the content refresh determination unit 132, and identify a location of the at least one content element on the page that is displayed on the display 104 based on the content ID. The driver 112 then transmits instructions to cause the display to refresh the at least one content element corresponding to the content ID at the identified page location. According to one aspect, the driver 112 may be configured to identify the location of at least one content element to be refreshed on the displayed page by referring to information associated with a page ID of the page as generated by the ID generating unit 130. Embodiments of the invention may thus allow for faster updating and/or refreshing of a displayed page by providing for the update of discrete elements of the page, without requiring updating of the entire content of the displayed page.

Referring to FIG. 3B, an embodiment of a display 104 configured to display the information received from the information processing apparatus 100 is shown. According to this embodiment, the display 104 comprises an instruction receiving unit 134 that is configured to receive display instructions for display of the content from the information processing apparatus 100. For example, the instruction receiving unit 134 may be an application, device or combination thereof that is capable of receiving the display instructions for the display of the content, where the content may comprise a page have a plurality of content elements. The instructions receiving unit 134 may also be configured to receive refresh instructions from the information processing apparatus 100 for refreshing a content element at a location on the displayed page. The display 104 according to this embodiment further comprises a display unit 136 that is configured to display the content including the page from the information processing apparatus 100 in accordance with the display instructions. The display unit 136 may also be configured to refresh the content element at the location on the displayed page in accordance with the refresh instructions.

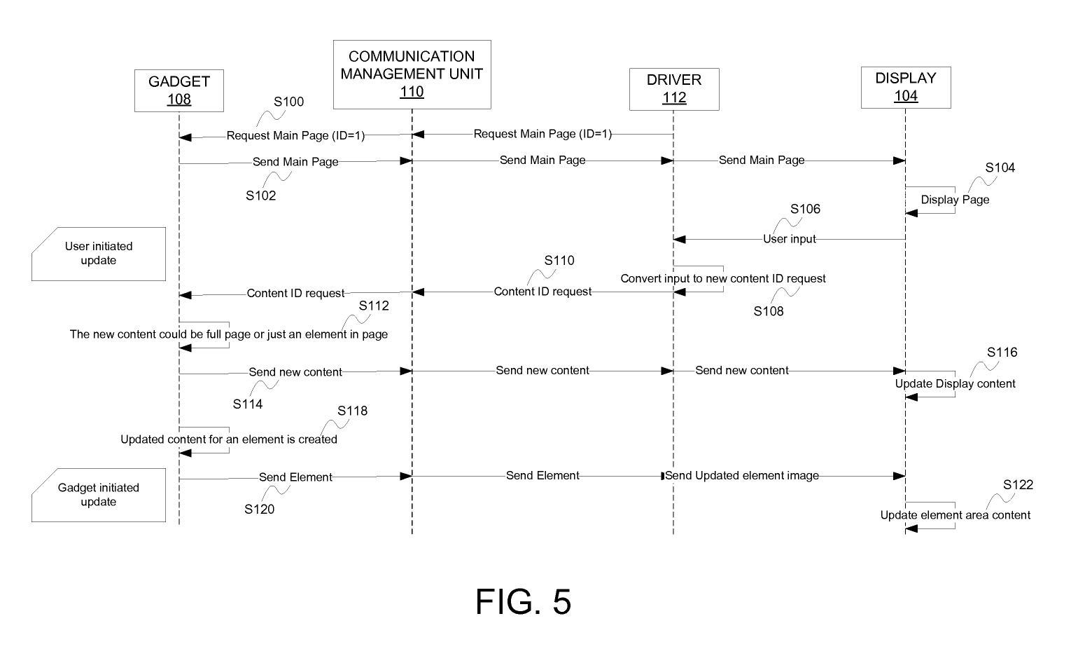

FIG. 4 is a block diagram of an internal architecture of an information processing apparatus 100 that is configured to transmit instructions to the display 104 to update and/or refresh the display content thereon, according to an exemplary embodiment of the present invention, such as for example an information processing apparatus 100 comprising a host computer 25. Shown in FIG. 4 is a processor such as a CPU 20, which can be for example any type of microprocessor, and which is coupled via a bus 21 to other hardware components, such as a memory 32. Also, interfacing with bus 21 may be, for example, a printer interface 22 that allows the information processing apparatus 100 to communicate with a local printer (not shown), a network interface 23 that enables communication between the information processing apparatus 100 and a network, such as for example a wireless network that is communicatively coupled with an auxiliary display 104, a modem interface 26 that enables communication between the information processing apparatus 100 and an internal modem (not shown), a display interface 27 that interfaces with a display monitor, such as a primary display (not shown), a keyboard interface 30 that interfaces with a keyboard (not shown), and mouse interface 29 that interfaces with a mouse (not shown).

The internal architecture of the information processing apparatus 100 may further comprise a read only memory (ROM) 31 that stores invariant computer-executable process steps for basic system functions such as basic I/O, start-up, or reception of keystrokes from a keyboard. Main random access memory (RAM) 32 can provide CPU 20 with memory storage that can be accessed quickly to control and/or operate software programs and/or applications therewith.

Also shown in FIG. 4 is disk 3, which may be a computer-readable medium, such as for example a hard drive, that is configured to store applications thereon, where the application may be for example, an operating system, web browser, and other applications, as well as data files. For example, the disk 3 may be configured to store computer-executable instructions, such as in the form of program code, that can be read out and executed by a processor to perform functions corresponding to those performed by one or more of the gadgets 108, communication management unit 110, driver 112, content generation unit 128, ID generating unit 130, and content refresh determination unit 132, as well as other functions performed by the information processing apparatus 100 as described herein. For example, FIG. 4 illustrates the disk as having the device driver 112 stored thereon. According to an exemplary embodiment, at least one processor provided as a part of the information processing apparatus 100, such as the CPU 20, is programmed to execute processing so as to control and/or operate one or more of the units and/or applications of the information processing apparatus 100 as described herein, such as for example one or more of the content generation unit 128, ID generating unit 130, content refresh determination unit 132 and device driver 112, and optionally other software and/or hardware of the information processing apparatus 100, such that auxiliary display refresh and/or updating according to aspects of the invention can be achieved.

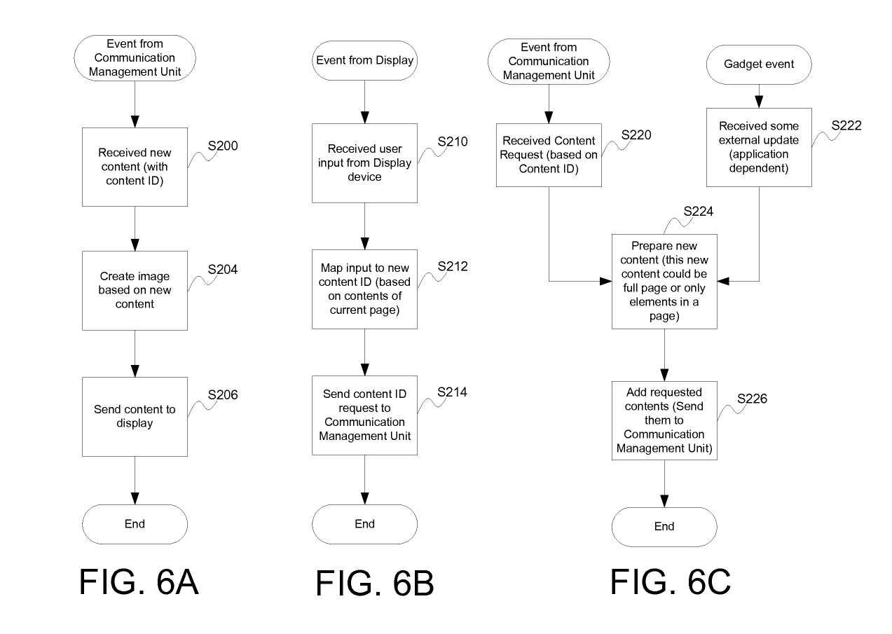

FIG. 5 is a diagram illustrating embodiments of process flows using content IDs for updating and/or refreshing one or more of the plurality of content elements displayed on a page. The update may be one requested by the display 104 via the driver 112, for example by a user viewing and/or operating the display 104, and the update may also be one that is initiated by the gadget 108 itself. The embodiment as shown illustrates the flow of information between a gadget 108 installed on the information processing apparatus 100, the communication management unit 110, the driver 112, and the display 104 during updating and/or refreshing of the display.

In an embodiment of a process flow corresponding to a display-initiated update (steps S100-S116), a first step (step S100) involves requesting a main or initial page of content from the gadget 108 by the driver 112 via the gadget communication management unit 110. Upon receipt of this request, the gadget 108 sends the content corresponding to the main page to the driver 112 via the communication management unit 110, with the driver 112 further transmitting instructions to the display 104 to cause a display of the content (step S102). Upon receiving the instructions, the display 104 displays the received content (step S104).

Once the main page has been displayed on the display 104, a user may input a request for a display of further content and/or other update, such as for example by selecting an option shown on the displayed page, or by otherwise inputting instructions requesting updated content. The user input instructions requesting the updated content are sent to the driver 112 of the information processing apparatus 100 (step S106), which converts the inputted request for the content to a content ID of the content corresponding to the request (steps S108). The driver 112 sends a request for the content corresponding to the content ID to the gadget 108 via the gadget communication management unit 110 (step S110). The request for content corresponding to the content ID is received by the gadget 108, and the requested content is generated for the purposes of transmission back to the display (step S112). It is furthermore noted that while the request for updated content is illustrated herein as being a request for an element on the page, as identified by the content ID, the request for the updated content may also be a request for updating of the full page, as identified for example by a page ID, as well as a request for updating a plurality of content elements on a page, as identified by their respective content IDs. The gadget 108 generates the content corresponding to that requested, and transmits the content to the display 104 via the communication management unit 110 and driver 112 (step S114). The display 104 may then update and/or refresh at least a portion of displayed page based on the newly received content (step S116).

In a process flow corresponding to a gadget-initiated update (steps S118-S122), a first step (step S118) involves the generation of updated content for at least one content element among the plurality of content elements displayed on a page. The generation of the updated content may also optionally comprise updating of the entire display page. Such gadget-initiated updating may occur, for example, when information that is provided by a web service and/or local application connected to the gadget 108 is updated, such as for example when weather or traffic information provided by a web service is automatically updated. The gadget-initiated updating may also occur, for example, when a user of the information processing apparatus 100 operates one of the gadgets 108 via a main display of the apparatus 100, or when a user otherwise modifies output of one or more of the gadgets 108. Once the gadget 108 generates the updated content, the updated content is transmitted to the display 104 via the gadget communication management unit 110 and driver 112 (step S120). The display 104 updates and/or refreshes at least a portion of displayed page based on the newly received content (step S122).

Accordingly, the gadget 108 may either receive a request for updated display content and/or may itself initiate an update of the information displayed on the display 104. That is, in the case where the gadget 108 initiates the update of a single element of the entire page, or when content ID of the content requested by the driver 112 corresponds to the content ID of one or more discrete elements of the page, as opposed to the content ID for the content of the full page, the gadget 108 may generate content corresponding only to the particular element to be updated. The content for this element is sent to the driver 112 via the gadget communication management unit 110. The driver 112 identifies a location of the at least one content element on the displayed page, based on the content ID, and transmits instructions to cause the display 104 to refresh the content element corresponding to the content ID at the identified page location. Thus, the system flow as shown may be capable of refreshing one or more elements of the page shown on the display 104 according to a content ID corresponding thereto. The system flow as shown may thus allow for partial refresh of the display 104, namely refresh of the particular requested element, without requiring refresh of the entire displayed page.

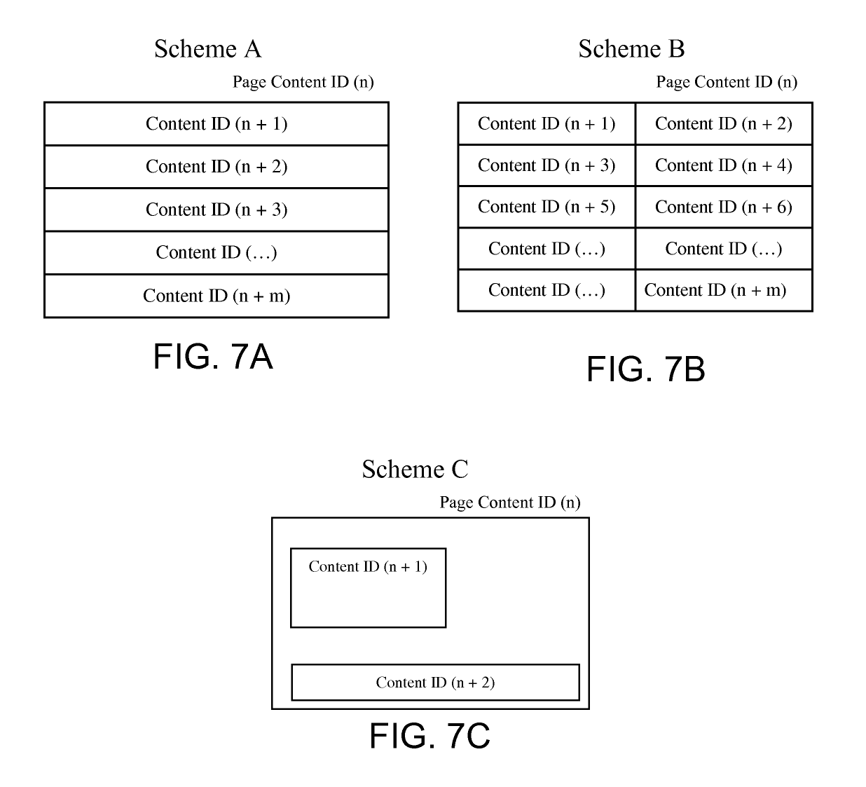

FIG. 6A is a block diagram illustrating an embodiment of a process flow for the display of contents on the display 104 from one or more gadgets 108 on the information processing apparatus 100. According to the embodiment as described herein, one or more steps in the process flow as shown may be performed by the driver 112, however the invention is not limited thereto, and other components of system 102 may also operate to perform one or more steps in the process flow. According to the process flow, an event is initiated by the communication management unit 110, which event may correspond to either the receipt of a main or initial page, or updated content, from one or more gadgets 108. The generated content (either updated or initial) is received by the driver 112 from the gadget communication management unit 110 (step S200). The generated content is also tagged with at least one ID that identifies the content, such as an ID for an updated content element. The driver 112 generates instructions that enable the display 104 to display the received content, such as by creating an image based on the newly received content (step S204), and sends the updated page content to the display 104 for display thereon (step S206).

FIG. 6B is a block diagram illustrating an embodiment of a process flow for a request originating from the display 104 for an update of display contents. Such a request may be made, for example, in accordance with user input made to select a display of information on the display 104, such as for example when a user inputs instructions on a rmote device to request the display of updated information thereon. As in the process flow described in FIG. 6A, one or more steps in the process flow as shown may be performed by the driver 112, however the invention is not limited thereto, and other components of the information processing apparatus 100 may also operate to perform one or more steps in the process flow.

According to this embodiment, the display 104 initiates an event, such as a request for updated content based on user input, which request is transmitted to the driver 112 of the information processing apparatus 100 (step S210). The driver 112 maps the user input corresponding to the request to the content ID of an element that is to be updated in response thereto (step S212), based on a predetermined format of the page and the content elements contained therein. The driver 112 sends a request for the content of an element to be updated, based on the determined content ID, to the gadget communication management unit 110 (step S214), which request is transmitted to the corresponding gadget 108 for generation of the requested updated content.

FIG. 6C is a block diagram illustrating an embodiment of a process flow for the generation of display content as initiated by either or both of the communication management unit 110 and the gadget 108. The communication management unit-initiated event may correspond to, for example, a request originating from the driver 112 and/or display 104 for initial or updated content. The gadget-initiated event may correspond to, for example, a gadget-initiated update of information, such as due to an external update of information from another application and/or user of the information processing apparatus 100. The gadget-initiated event may also correspond to, for example, an external update arising from an update of information provided by a web service, such as an update of weather, traffic or stock information provided to the gadget 108 via the internet. According to one aspect of the invention, one or more steps in the process flow as shown may be performed by one or more gadgets 108, however the invention is not limited thereto, and other components of the information processing apparatus 100 may also operate to perform one or more steps in the process flow.

According to the process flow as shown in FIG. 6C, an event may be initiated by the gadget communication management unit 110 to request content from the gadget 108, which may be either a main or initial page, or may be updated content based on a content ID. An event may also and/or additionally be initiated by the gadget 108 itself in response to an external update. The gadget 108 then receives one or more of the request for content from the gadget communication management unit 110 and the external update request (steps S220 and S222). The gadget 108 generates the content corresponding to at least one of the request from the gadget communication management unit 110 and the external update (step S224). The generated content can include generation of an entire page, or generation of only one or more elements on the page, as indicated for example by the element content IDs included in the request from the communication management unit 110. For example, the gadget 108 may generate updated content corresponding to content IDs for requested elements, and may also update content, including particular content elements, that was not specifically requested by the gadget communication management unit 110, but that has been updated by an external source. The content as newly generated by the gadget 108 is transmitted to gadget communication management unit 110 (step S226), for providing to the display 104.

Thus, according to aspects of the invention, the content ID corresponding to content to be updated on the display 104 may be used to represent a discrete area on the page, corresponding to a content element. While the content IDs may correspond to the content elements, an ID that corresponds to the content for the entire page may also be used, such as when refreshing and/or updating of an entire page is initiated. Refreshing according to content IDs for an element may be faster than refreshing the entire page content, because less data may be required to be transferred from the gadget 108 and converted into a form suitable for the display 104. For example, in the case of a display 104 on a device that displays bitmap data, the amount of data that would need to be sent if an entire page were updated could be substantial. Thus, sending data corresponding to only one or just a few elements of the page may yield a substantial improvement in the speed with which the page is refreshed. Also, poor performance of the display 104, and/or a poor user experience with the display 104 due to a slow screen update, may be avoided by refreshing only specific elements on the page.

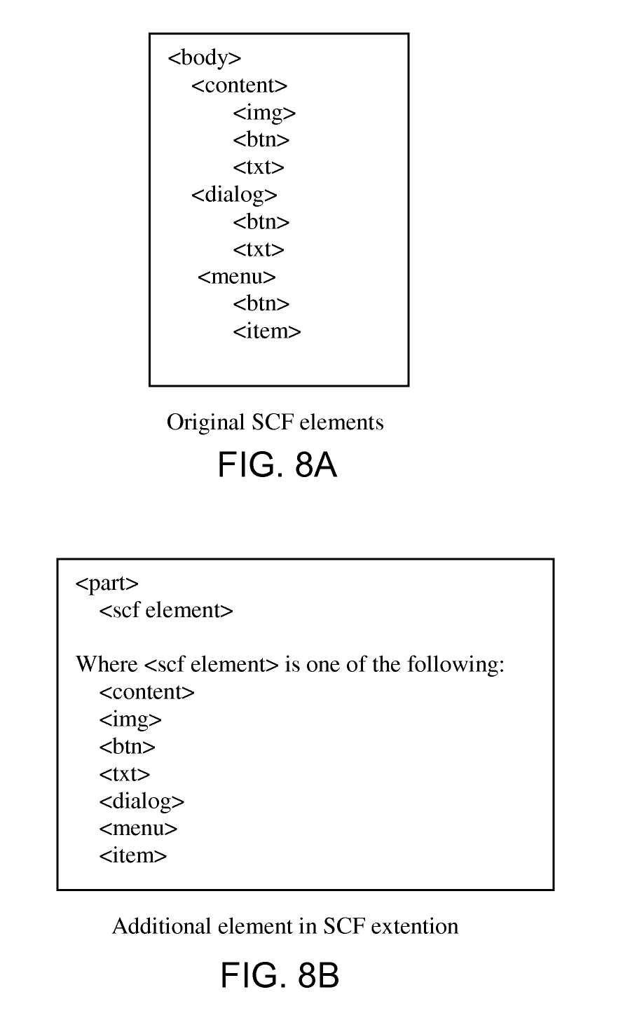

According to an embodiment of the invention, the content elements identified by the content IDs may each correspond to a particular location on the page shown on the display 104. For example, as shown in Schemes A and B in FIGS. 7A and 7B, the page shown on the display 104 may be divided into different bands or areas corresponding to each content element, with each content element having a different content ID corresponding thereto. In Scheme A as shown in FIG. 7A, the page shown on the display 104 has the page content ID (n), and is divided into horizontal rows, each of which corresponds to a different content element having its own content ID (n+1, n+2, n+3, . . . n+m). In Scheme B as shown in FIG. 7B, the page shown on the display 104 has the page content ID (n), and is divided into both horizontal rows as well as two columns, with each element defined by the rows and columns being identified by a different content ID (n+1, n+2, n+3, . . . n+m). According to Scheme C, as shown in FIG. 7C, the page shown on the display 104 is divided into areas that are predetermined by the gadget 108, which areas may generally correspond to a predetermined shape and/or size of the content elements to be displayed on the page. For example, the full page content may correspond to a page content ID (n), with the full page content including a central area of page that corresponds to a content element having a content ID (n+1), and a lower text area of the page that corresponds to a separate content element having a content ID (n+2). Thus, if it is determined that the content of an element displayed on the screen is to be updated, the display 104 may be updated by refreshing those particular areas of the screen corresponding to the content IDs of the elements to be updated.

According to one embodiment, the use of content IDs corresponding to the discrete elements on the page may be implemented by providing an extension of the SCF endpoint schema 111 used for communication between the gadgets 108, the communication management unit 110 and the driver 112. For example, the extended SCF endpoint schema as described herein may include one or more of the following attributes and/or elements:

(1) refresh ID An attribute added to elements of the SCF endpoint that contains the content ID of the contents that are to be sent to refresh the information represented by the element. If the value is 0 or if the attribute is not present, then this element is not refreshed independently from the page;

(2) numColumns An attribute added for an <img> element, specifying the number of columns into which an image is divided (for example, as in Scheme A shown in FIG. 6A);

(3) numRows An attribute added for the <img> element, specifying the number of rows into which an image is divided (for example, as in Scheme A and Scheme B shown in FIGS. 6A and 6B);

(4) part An element that represents the contents of an element to be refreshed. Each part element also has a parent ID attribute that links the part to the full page Content ID. The part element contains a single element that contains the new contents for the element; and

(5) parent ID An attribute that identifies a parent page containing the corresponding part.

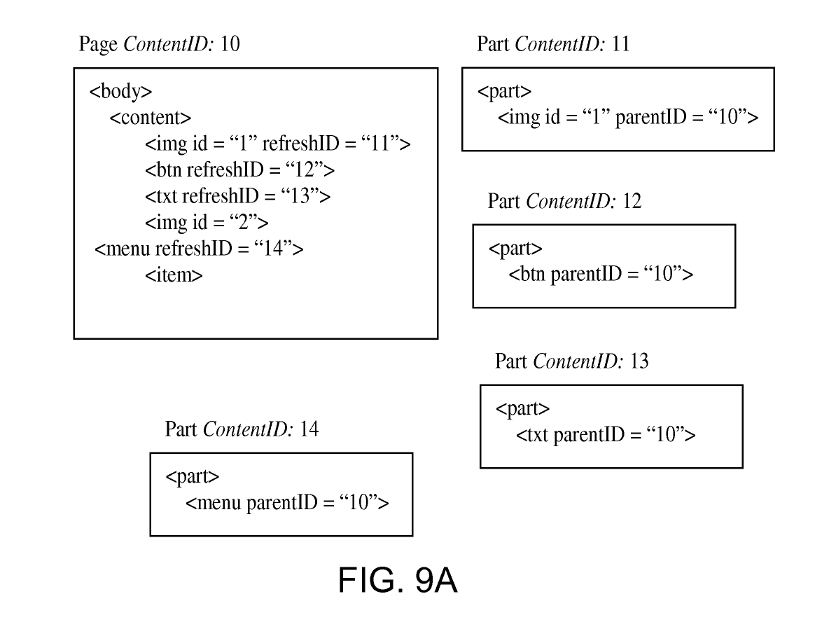

The schema and/or SCF endpoint elements may also include other elements and/or attributes other than those specifically described, such as for example elements conventionally used for SCF endpoint. FIG. 8A illustrates examples of SCF elements used for the display of a page. As can be seen from the figure, the original content element <body> may include the elements <content>, <dialog> and <menu>, with the <content> element further comprising the <img>, <btn> and <txt> elements (image, button and text elements), the <dialog> element further comprising the <btn> and <txt> elements (button and text elements), and the <menu> element further comprising the <btn> and <item> elements (button and item elements). Accordingly, with the SCF endpoint, a page to be displayed can be divided into discrete elements (e.g., content, menu, image, button, text, etc.) having separate locations on the page.

FIG. 8B illustrates examples of elements corresponding to those proposed herein for the SCF extension, to allow for individual element refreshing and/or updating. In the figure, the element <part> is depicted as comprising <scf element>, where <scf element> may be one or more of <content>, <img>, <btn>, <txt>, <dialog>, <menu> and <item> elements (content, image, button, text, dialog, menu and item elements). Accordingly, the different SCF elements (content, image, button, text, dialog, etc.) may be individually updated and/or refreshed on the displayed page.

A diagram illustrating an embodiment of the relationship between the page, attributes and/or elements in the extended SCF endpoint schema is depicted in FIG. 9A. As shown therein, for the page corresponding to ContentID 10, all of the elements that have the attribute refreshID can be refreshed independently from the page and/or the other elements in the page. Thus, the only element depicted therein that cannot be refreshed independently of the entire page is the element corresponding to <img id =“2”>. Accordingly, as can be seen from FIG. 9A, updating of elements on the page can be performed by requesting the update according to the content ID (e.g., Part ContentID 11, 12, 13, 14) of a particular <part> (e.g., content element) to be updated, which <part> is linked back to the original page by the parent ID. The embodiment of the endpoint schema as shown can thus provide a template for an initial format of the page, including the location of the elements on the page, such as a template used by the driver 112 for display of the page having the format specified therein. This template can then further be referred to, for example by the driver 112, to map content elements that are to be updated with their corresponding content IDs, such that the content elements can be individually updated without requiring update of the entire displayed page.

FIG. 9B is a diagram illustrating yet another embodiment of a relationship between the page, attribute and elements that can be used for updating content elements shown on a display. FIG. 9B may be capable of, for example, realizing Scheme B as shown in FIG. 7B, as well as Scheme A as shown in FIG. 7A (corresponding to the case where numColumns=1). In the example as shown, the “refreshID” corresponds to the content ID for the first “piece” of the image (i.e., first column, first row). Subsequent “pieces” (i.e., grid or matrix elements) can also be similarly specified. Accordingly, by using the extended SCF schema as shown, the gadget 108 can send updates to the display 104 for individual content elements displayed at discrete locations on the display 104, without requiring update of the entire page contents.

Some exemplary systems 102 in which embodiments of the invention may be utilized to allow for the refreshing of portions of a displayed page, without requiring update of the entire displayed page, may be as follows. As a first example, an exemplary system 102 may comprise an information processing apparatus 100 corresponding to a desktop computer with a desktop monitor, with the desktop monitor having attached thereto a smaller rotatable auxiliary display 104 that is capable of displaying information from one or more gadgets 108 running on the desktop computer. Such a system may be useful, for example, for gaming systems that allow a gamer to group game controls or other information on the auxiliary display 104, thereby clearing the screen for viewing of the game on the desktop monitor. As yet another example, an exemplary system 102 may comprise a desktop computer, and a wired or wireless keyboard for use therewith, the keyboard having an auxiliary display 104 integrated therein that may be used to notify a user of various information, such as for example information related to a computer game or other application being run on the computer. As a further example, an exemplary system 102 may comprise a computer and a computer gaming controller for use therewith, with the controller comprising an auxiliary display 104 integrated therein to notify a user of game-related information. For example, aspects of the invention may be implemented in one or more of the Logitech® G19 Keyboard for gaming or the Logitech® G13 Advanced Gameboard available from Logitech®.

As yet another example, aspects of the invention may be implemented in a system 102 comprising a laptop computer having an auxiliary display 104 that corresponds to a secondary screen that is integrated into the keyboard area of the laptop computer, such as for example in the Fujitsu® Lifebook N7010 with Touchscreen App Launcher available from Fujitsu®. The secondary screen may be used as, for example, an application launcher, or to play media and/or for photo viewing. As yet another example, aspects of the invention may be implemented in a system 102 comprising a laptop computer having an auxiliary display 104 that corresponds to an integrated touchscreen trackpad, such as for example in the Sharp® Mebius NJ70A netbook available from Sharp®. As a further example, an exemplary system 102 may comprise a desktop computer 100 and a USB device having an auxiliary display 104 built therein to allow viewing of information from gadgets 108 on the desktop computer, even when a main monitor of the desktop computer is off.

According to one embodiment, the functions according to the present embodiment as described in FIGS. 1-9B may be achieved by a system 102 comprising an information processing apparatus 100 having one or more of the gadget management unit 106 configured to manage the gadgets 108, the communication management unit 110, and driver 112, such as for example in the form of one or more installed programs as shown in FIG. 4. In such a case, the program and the associated data may be supplied to the information processing apparatus 100 using a storage medium such as disk 3 including, but not limited to, a hard drive, an optical disc, a flash memory, a floppy disc, or an external storage medium via a network or direct connection.

In this way, the storage medium may store the software program code that achieves functions according to aspects of the above-described exemplary embodiments. The storage medium may be supplied to a system or an apparatus. Aspects of the present invention may also be achieved by causing the processor 20 (such as a central processing unit (CPU) or micro-processing unit (MPU)) of a system 102 or apparatus to read and execute the software program code, so as to provide control and/or operation of one or more of the units and/or applications described herein.

In such a case, the program code read out of the storage medium may realize functions according to aspects of the above-described embodiments. Therefore, the storage medium storing the program code can also realize aspects according to the present invention.

While aspects of the present invention have been described with reference to exemplary embodiments, it is to be understood that the invention is not limited to the disclosed exemplary embodiments. The scope of the following claims is to be accorded the broadest interpretation so as to encompass all modifications, equivalent structures and functions.

What is claimed is:

1. A system comprising:
an information processing apparatus; and
a display configured to display content from the information processing apparatus,
wherein the information processing apparatus comprises:
at least one processor coupled via a bus to a memory, the processor being programmed to control one or more of:
a content generation unit configured to generate content for display, wherein the content comprises a page having a plurality of content elements;
an ID generating unit configured to generate content IDs corresponding to each of the content elements in the page of the content generated by the content generation unit;
a content refresh determination unit configured to determine a content ID of at least one content element to be refreshed on the display; and
a device driver configured to receive the content generated by the content generation unit and transmit instructions to the display to cause display of the content thereon,
wherein the device driver is configured to receive the content ID for the at least one content element to be refreshed on the display, as determined by the content refresh determination unit, identify a location of the at least one content element on the displayed page based on the content ID, and transmit instructions to cause the display to refresh the at least one content element corresponding to the content ID at the identified page location.

2. The system according to claim 1, wherein the device driver is configured to transmit instructions to refresh the at least one content element corresponding to the content ID, without refreshing the rest of the page.

3. The system according to claim 1, wherein the ID generating unit is configured to generate a content ID that is associated with information identifying the page to which the content element belongs.

4. The system according to claim 1, wherein the ID generating unit is configured to generate a content ID that is associated with information identifying a type of the content element.

5. The system according to claim 4, wherein the type of content element comprises at least one of an image, button, text, content, dialog, menu and item.

6. The system according to claim 1, wherein the ID generating unit is further configured to generate a page ID for each page of content generated by the content generation unit, the page ID being associated with information identifying each content element in the page.

7. The system according to claim 6, wherein the device driver is configured to identify the location of the at least one content element on the displayed page by referring to the information associated with the page ID of the page.

8. The system according to claim 6, wherein the page ID is associated with information identifying a row and a column where a content element is located in an image included in the page.

9. The system according to claim 1, wherein the display is either separate from or integrated into the information processing apparatus.

10. A method of displaying content from an information processing apparatus on a display, the method comprising:
generating the content for display, the content comprising a page having a plurality of content elements;
generating content IDs corresponding to each of the content elements in the generated content page;
determining a content ID of at least one content element to be refreshed on the display;
displaying the generated content including the page on the display;
identifying a location of the at least one content element to be refreshed on the displayed page based on the content ID of the at least one content element; and
refreshing the at least one content element corresponding to the content ID at the identified page location on the display.

11. A computer readable medium having stored thereon computer executable instructions for displaying content from an information processing apparatus on a display according to the method of claim 10.

12. An information processing apparatus configured to provide content for a display, the information processing apparatus comprising:
at least one processor coupled via a bus to a memory, the processor being programmed to control one or more of:
a content generation unit configured to generate the content for the display, wherein the content comprises a page having a plurality of content elements;
an ID generating unit configured to generate content IDs corresponding to each of the content elements in the page of the content generated by the content generation unit;
a content refresh determination unit configured to determine a content ID of at least one content element to be refreshed on the display; and
a device driver configured to receive the content generated by the content generation unit and transmit instructions to the display to cause display of the content thereon,
wherein the device driver is configured to receive the content ID for the at least one content element to be refreshed on the display, as determined by the content refresh determination unit, identify a location of the at least one content element on the displayed page based on the content ID, and transmit instructions to cause the display to refresh the at least one content element corresponding to the content ID at the identified page location.

13. A method of providing content for a display from an information processing apparatus, the method comprising:
generating the content for the display, wherein the content comprises a page having a plurality of content elements;
generating content IDs corresponding to each of the content elements in the generated content page;
determining a content ID of at least one content element to be refreshed on the display; and
transmitting instructions to the display to cause display of the generated content thereon including the page;
identifying a location of the at least one content element to be refreshed on the displayed page based on the content ID of the at least one content element; and
transmitting instructions to the display to cause refreshing of the at least one content element corresponding to the content ID at the identified page location.

14. A computer readable medium having stored thereon computer executable instructions for providing content for a display from an information processing apparatus according to the method of claim 13.
